(19) United States
(12) Patent Application Publication
(10) Pub. No.: US 2026/0303810 A1
(43) Pub. Date: Oct. 1, 2026

(54) PARAMETER DERIVATION FOR MULTI-HYPOTHESIS CROSS-COMPONENT PREDICTION (MHCCP)

(71) Applicant: Tencent America LLC, Palo Alto, CA (US)

(72) Inventors: Tianqi LIU, Palo Alto, CA (US); Liang Zhao, Palo Alto, CA (US); Madhu Peringassery Krishnan, Palo Alto, CA (US); Ting-Lan Lin, Palo Alto, CA (US); Shan Liu, Palo Alto, CA (US)

(21) Appl. No.: 19/321,139

(22) Filed: Sep. 5, 2025

Related U.S. Application Data
(60) Provisional application No. 63/777,667, filed on Mar. 25, 2025.

(51) Int. Cl. H04N 19/132; H04N 19/159; H04N 19/176; H04N 19/186

(52) U.S. Cl. CPC H04N 19/132; H04N 19/159; H04N 19/176; H04N 19/186

(57) ABSTRACT

The various implementations described herein include methods and systems for coding video. In one aspect, a video bitstream includes a current coding block of an image frame. When a multi-hypothesis cross-component prediction (MHCCP) mode is enabled, a computing system determines that three model parameters are used in the MHCCP mode, and the three model parameters correspond to a linear term, a non-linear term, and an offset term. The set of one or more luma samples are combined using the three model parameters to generate the first chroma sample of the current coding block. The computing device reconstructs the current image frame including the first chroma sample of the current coding block.

### RELATED APPLICATION

This application claims priority to U.S. Provisional Patent Application No. 63/777,667, entitled “Parameter Derivation for MHCCP,” filed Mar. 25, 2025, which is hereby incorporated by reference in its entirety.

### TECHNICAL FIELD

The disclosed embodiments relate generally to video coding, including but not limited to systems and methods for processing video data using cross-component prediction.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes cross component intra or inter prediction of video data in a cross component prediction (CCP) mode where each of a plurality of samples of a second color component of a current coding block is determined based on one or more associated samples of a first color component of a reference coding block (e.g., the current coding block itself). The CCP mode corresponds to a multi-tap model that includes a number (N) of taps. Each tap is selected from a sample of the first color component, the one or more associated neighboring samples of the first color component, a nonlinear term, and an offset term. The selected taps are combined using a plurality of model parameters to determine the sample of the second color component. In some embodiments, the sample of the first color component is a luma sample, and the sample of the second color component is a chroma sample. The chroma sample is a weighted combination of terms selected from a respective luma sample, one or more neighboring luma sample, a nonlinear term, and the offset term. In some embodiments, when the CCP mode is enabled for a current coding block, samples of a respective reference area are applied to determine the model parameters. Particularly, in some embodiments, in a multi-hypothesis CCP (MHCCP) mode, three model parameters correspond to a linear term, a non-linear term, and an offset term, and are applied to combine a set of one or more samples of the first color components using the three model parameters and generate a sample of the second component of the current coding block.

In some embodiments, when samples of a first color components are applied to determine samples of a second color component, each sample of the first color component is a luma sample, and each sample of the second color component is a blue-difference chroma (Cb) sample or a red-difference chroma (Cr) component. Alternatively, in some embodiments, the first color component is one of the red, green, and blue colors, and the second color component is another one of the red, green, and blue colors. Alternatively, in some embodiments, the first color component and the second component correspond to a color format that is distinct from a YCbCr color format and an RGB color format.

In accordance with some embodiments, a method of video decoding is provided. The method includes receiving a video bitstream including a current coding block of a current image frame, and the video bitstream includes a first syntax element for a multi-hypothesis cross-component prediction (MHCCP) mode. The method further includes, based on the first syntax element, determining that the MHCCP mode is enabled to reconstruct a first chroma sample of the current coding block based on a set of one or more luma samples, determining that three model parameters are used in the MHCCP mode, wherein the three model parameters correspond to a linear term, a non-linear term, and an offset term, combining the set of one or more luma samples using the three model parameters to generate the first chroma sample of the current coding block, and reconstructing the current image frame including the first chroma sample of the current coding block.

In accordance with some embodiments, a method of video encoding is provided. The method includes receiving video data comprising a current coding block of a current image frame, encoding the current image frame, transmitting the encoded current image frame via a video bitstream, and signaling, via the video bitstream, a first syntax element for a multi-hypothesis cross-component prediction (MHCCP) mode indicating whether to reconstruct a first chroma sample of the current coding block based on a set of one or more luma samples. When the MHCCP mode is enabled, the set of one or more luma samples are combined using the model parameters corresponding to a linear term, a non-linear term, and an offset term to generate the first chroma sample of the current coding block.

In accordance with some embodiments, a method of bitstream conversion is provided. The method includes obtaining a source video sequence including a current image frame having a current coding block and performing a conversion between the source video sequence and a video bitstream. The video bitstream includes the current image frame having the current coding block and a first syntax element for a multi-hypothesis cross-component prediction (MHCCP) mode indicating whether to reconstruct a first chroma sample of the current coding block based on a first luma sample and a set of one or more luma samples. When the MHCCP mode is enabled, the set of one or more luma samples are combined using the model parameters corresponding to a linear term, a non-linear term, and an offset term to generate the first chroma sample of the current coding block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system, in accordance with some embodiments.

FIG. 2A is a block diagram illustrating example elements of an encoder component, in accordance with some embodiments.

FIG. 2B is a block diagram illustrating example elements of a decoder component, in accordance with some embodiments.

FIG. 3 is a block diagram illustrating an example server system, in accordance with some embodiments.

FIG. 4 illustrates an example scheme for generating a first chroma sample from one or more luma samples in accordance with some embodiments.

FIG. 5A is a diagram of an example MHCCP mode having a horizontal filter shape, in accordance with some embodiments, and FIG. 5B is a diagram of an example MHCCP mode having a vertical filter shape, in accordance with some embodiments.

FIG. 6A is a diagram of another example MHCCP mode having a horizontal filter shape, in accordance with some embodiments, and FIG. 6B is a diagram of another example MHCCP mode having a vertical filter shape, in accordance with some embodiments.

FIG. 7A is a flow diagram of an example least mean square method applied using Gaussian elimination to determine model parameters, in accordance with some embodiments.

FIG. 7B is a flow diagram of an example method of approximating a division operation, in accordance with some embodiments.

FIG. 8A is an example current image frame in which a current coding block is located at a top boundary of a superblock, in accordance with some embodiments.

FIG. 8B is another example current image frame in which a current coding block is located within a superblock, in accordance with some embodiments.

FIG. 9 is a flow diagram illustrating an example method of decoding video, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video compression methods using intra prediction and inter prediction. Samples of a current coding block may be reconstructed from samples of a reference coding block based on a model having a plurality of model parameters. For example, the model is used to predict a chroma sample of the current coding block as a linear or nonlinear weighted sum of multiple inputs of luma samples of the reference coding block, which may be the same as the current coding block. A reference area associated with the current coding block and/or an associated reference coding block includes a plurality of reconstructed neighboring samples (e.g., luma and chroma samples), which are used to determine the plurality of model parameters of the model used to reconstruct the samples of the current coding block. For example, the model parameters may be determined by feeding neighboring reconstructed samples (e.g., in the reference area) of the current coding block and the reference coding block into a least mean square calculation kernel.

In some embodiments, the intra prediction mode can be cross-component prediction modes in which samples of a first color component (e.g., a first chroma sample) are determined using the reconstructed samples (e.g., one or more luma samples) of a second color component, while the current coding block can be a chroma block and the reference coding block can be a co-located luma block. Alternatively, in some embodiments, the intra prediction mode can be an intra block copy mode or an intra template matching mode. Samples of the current coding block are determined using a block vector that can be signaled (e.g., intra block copy) or implicitly derived (e.g., using template matching) to identify the reference coding block. Alternatively, in some embodiments, the inter prediction mode can be an illumination compensation mode, and samples are determined using the neighboring reconstructed samples of the current coding block and the reference coding block in a reference image frame based on a least mean square optimization.

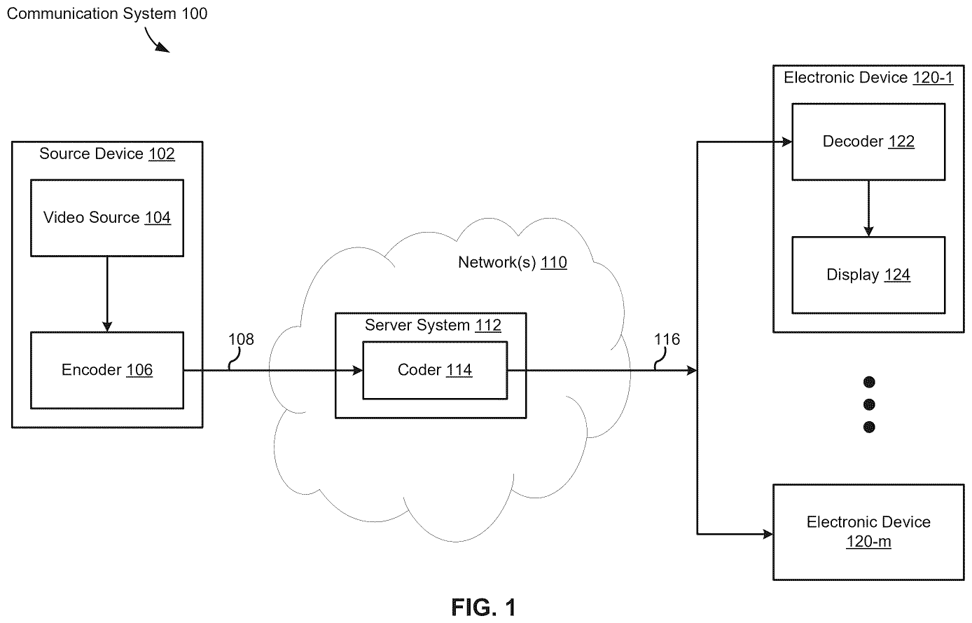

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

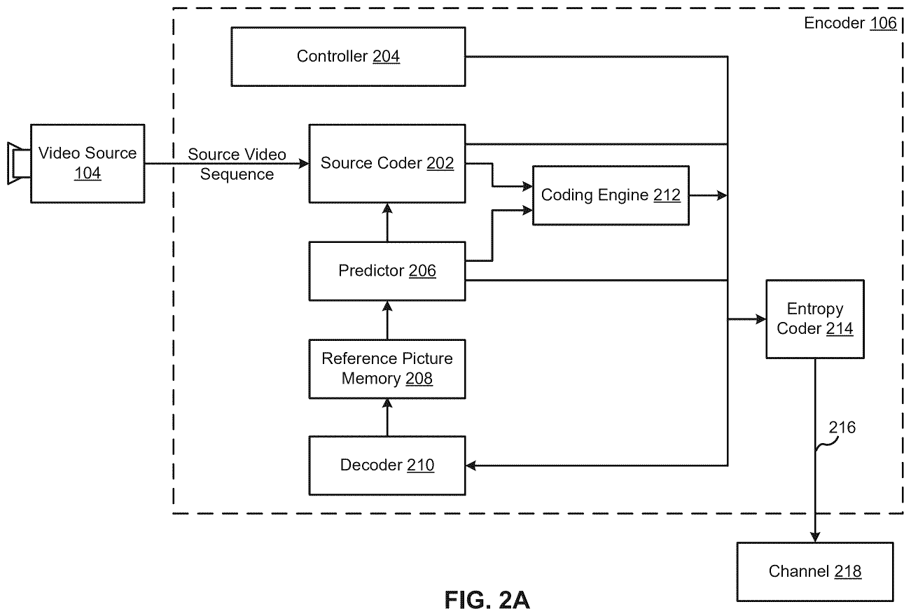

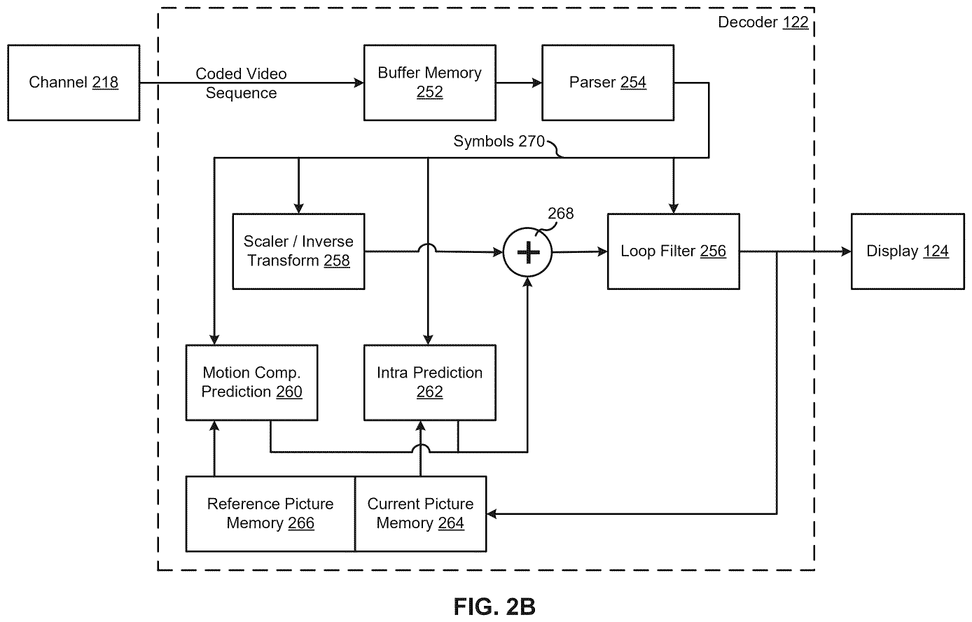

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

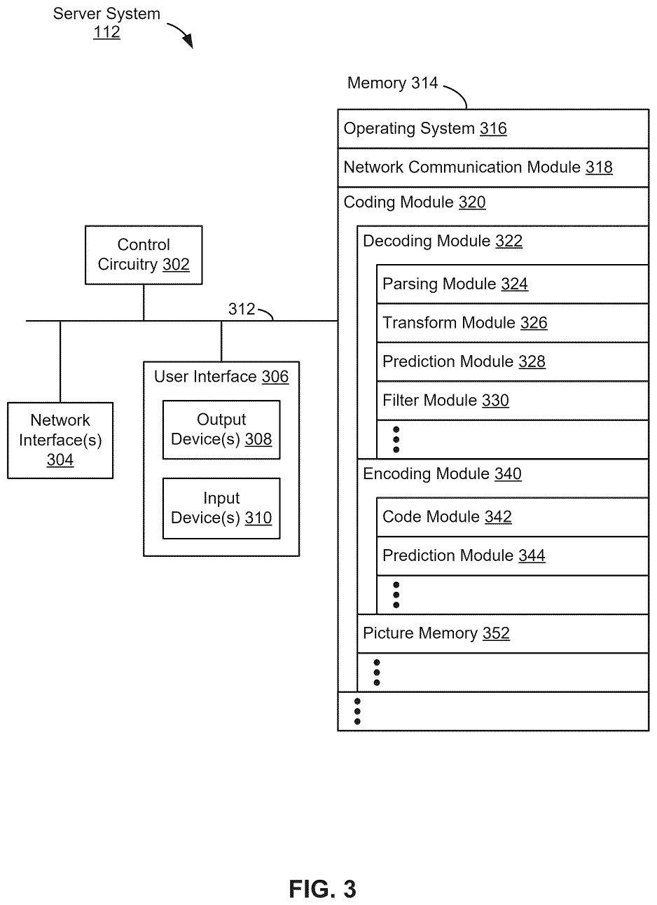

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

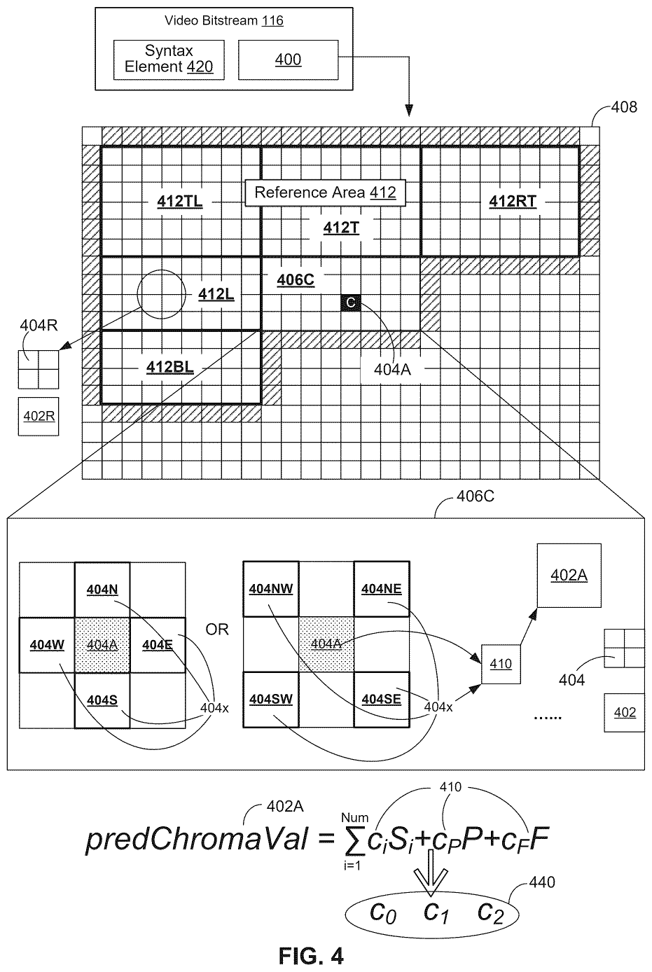

FIG. 4 illustrates an example scheme 400 for generating a first chroma sample 402A from one or more luma samples 404 (e.g., 404A and 404X) in a CCP mode (e.g., a multi-hypothesis CCP (MHCCP) mode), in accordance with some embodiments. In some embodiments, a video bitstream 116 includes a current coding block 406C of the current image frame 408 and a syntax element 420 for the CCP mode. The syntax element 420 indicates whether to reconstruct the first chroma sample 402A of the current coding block 406C based on a set of one or more luma samples 404 of a reference coding block based on a plurality of model parameters 410. Referring to FIG. 4, in an example, the reference coding block is the current coding block 406C itself. In some embodiments, the syntax element 420 is signaled in the video bitstream 116 at one of a block level, a superblock level, an image frame level, a slice level, a tile level, and an image sequence level for the current coding block 406C.

In some embodiments (FIG. 4), the CCP mode includes a cross-component intra prediction (CCIP) mode, and a current coding block 406C of a current image frame 408 is coded in the CCIP mode. In the CCIP mode, the current coding block 406C includes a chroma block, and corresponds to a reference coding block including a co-located luma block. A decoder 122 (FIG. 2B) determines each of a plurality of chroma samples 402 of the current coding block 406C based on one or more luma samples 404 of the reference coding block that have been reconstructed. In some situations, the CCIP mode includes a cross-component linear model (CCLM) mode in which a first chroma sample 402A is converted from a reconstructed luma sample 404A that is co-located with the chroma sample 402A based on a linear model. Alternatively, in some situations, the CCIP mode includes a convolutional cross-component mode (CCCM) in which a first chroma sample 402A is predicted directly from a plurality of reconstructed luma samples 404X that is located adjacent to the first luma sample 404A based on a filter shape of a filter. Alternatively and additionally, in some situations, the CCIP mode includes the MHCCP mode in which a first chroma sample 402A is generated by combining at least the first luma sample 404A that is collocated with the first chroma sample 402A and a plurality of hypothesis values using a plurality of weighing factors. The plurality of neighboring luma samples 404X of the first luma sample 404A are combined using a plurality of coefficients to generate the plurality of hypothesis values. Stated another way, in the MHCCP mode, the first luma sample 404A and the plurality of neighboring luma samples 404X are combined using a plurality of model parameters 410 (which are associated with the weighing factors and the coefficients) to generate the first chroma sample 402A. The first chroma sample 402A is a blue-difference chroma (Cb) sample or a red-difference chroma (Cr) component.

In some embodiments, a video bitstream 116 includes a syntax element 420 for an MHCCP mode. The first chroma sample 402A of the current coding block 406C is configured to be generated by combining at least the first luma sample 404A that is co-located with the first chroma sample 402A and one or more neighboring luma samples 404X of the first luma sample 404A using a plurality of model parameters (e.g., cᵢ, c_{P}, c_{B}). In accordance with a determination that the MHCCP mode is applied, the first chroma sample 402A is predicted according to the following model:

$$predChromaVal = {\sum }_{i = 0}^{N u m} {c}_{i} \cdot {S}_{i} + {c}_{E} \cdot E + {c}_{F} \cdot F \qquad ( 1 )$$

where predChromaVal is a predicted chroma value of the first chroma sample 402A; Num is a total number of neighboring luma samples 404X; Sᵢ is a luma value of the first luma sample 404A (where i is equal to 0) or a neighboring luma sample 404X (where i is greater than 0), which is indexed by i; E is a nonlinear term; F is an offset term; and cᵢ, c_{E}, c_{F} are model parameters. In an example, the nonlinear term E is equal to equal to (C×C+F)>>bit_depth, where C is a sample value of the first luma sample 404A, and bit_depth is the number of bits needed to represent luma samples of the current image frame 408 during encoding and decoding. In some embodiments, F is a median luma value, a middle luma value, or an average luma value of the luma samples 404 of the current coding block 406C. In another example, F is equal to 1<<(bit_depth−1). In the MHCCP mode, the chroma samples 402 of the current coding block 406C do not need to be transmitted in the video bitstream 116, thereby conserving a communication bandwidth of a video codec.

In some embodiments, each of the one or more neighboring luma samples 404X of the first luma sample 404A is immediately adjacent to, and shares at least one respective side or vertex with, the first luma sample 404A. In some embodiments, the one or more neighboring luma samples 404X include a subset or all of a north neighboring luma sample (also called a top luma sample) 404N, a south neighboring luma sample (also called a bottom luma sample) 404S, a west neighboring luma sample (also called a left luma sample) 404W, an east neighboring luma sample (also called a right luma sample) 404E, a northwest neighboring luma sample (also called a top left luma sample) 404NW, a southeast neighboring luma sample (also called a bottom right luma sample) 404SE, a southwest neighboring luma sample (also called a bottom left luma sample) 404SW, and a northeast neighboring luma sample (also called a top right luma sample) 404NE.

In some embodiments, equation (1) includes five terms, and represents a five tap model for determining the first chroma sample 402A of the current coding block 406C based on three linear terms (e.g., associated with the first luma sample 404A and neighboring luma samples 404W and 404E), the nonlinear term E, and the offset term F in the MHCCP mode. Alternatively, in some embodiments, equation (1) includes seven terms, and represents a seven tap model for determining the first chroma sample 402A of the current coding block 406C based on three linear terms (e.g., associated with luma samples 404A, 404W, 404E, 404N, and 404S), the nonlinear term E, and the offset term F in the MHCCP mode.

In some embodiments, equation (1) includes three model parameters c₀, cᵢ, and c₂ corresponding to a linear term, a non-linear term E, and an offset term F. The set of one or more luma samples are combined using the three model parameters to generate the first chroma sample 402A of the current coding block 406C.

In some embodiments, luma samples 404 and chroma samples 402 of the current coding block have different resolutions corresponding to a chroma subsampling scheme (e.g., 4:2:2 or 4:2:0).

In some embodiments, the plurality of model parameters cᵢ, c_{E}, and c_{F} are determined based on a set of one or more reference luma samples 404R and a set of one or more co-located reference chroma samples 402R within a reference area 412 of the current coding block 406C. The reference area 412 is located in the current image frame 408. Further, in some embodiments, the reference luma samples 404R of the reference area 412 are combined to re-generate one or more chroma samples 402A based on equation (1). In some embodiments, the set of one or more co-located reference chroma samples 402R and the one or more re-generated chroma samples are compared to generate a least mean square (LMS) value. The plurality of model parameters cᵢ, c_{E}, c_{F} are iteratively adjusted to reduce the LMS value, until the LMS value satisfies a predefined criterion (e.g., in which the LMS value is below a threshold LMS value or is minimized).

In some embodiments, the plurality of model parameters cᵢ, c_{E}, or c_{F} are at least partially derived based on chroma samples and luma samples within the reference area 412 of the current coding block 406C, and the reference area 412 includes one or more coding blocks (e.g., 4 coding blocks in FIG. 4) that are decoded prior to, the current coding block 406C. In some embodiments, a subset of the one or more coding blocks is immediately adjacent to the current coding block 406C. In some embodiments, a subset of the one or more coding blocks are separated from the current coding block 406C by one or more coding blocks. In some embodiments, the reference area 412 includes at least a portion of one or more rows above the current coding block 406C and/or a portion of one or more columns to the left of the current coding block 406C. For example, referring to FIG. 4, the reference area 412 includes seven rows of luma samples 404R above the current coding block 406C and nine columns of luma reference samples 404R to the left of the current coding block 406C. The reference area 412 may include a padded row and a padded column (e.g., shaded in FIG. 4).

Additionally, in some embodiments, the reference area 412 of the current coding block 406C includes one or more of: a top left reference region 412TL, a top reference region 412T, a top right reference region 412TR, a bottom left reference region 412BL, and a left reference region 412L. In an example, the reference area 412 includes the top reference region 412T and the left reference region 412L. Each of the reference regions includes one or more coding blocks. Stated another way, in some embodiments, the reference area 412 includes at least a portion of a plurality of rows above the current coding block 406C and/or a portion of a plurality of columns to the left of the current coding block 406. For example, referring to FIG. 4, the reference area 412 includes a first portion of 6 rows of chroma samples above the current coding block 406C and a second portion of 8 columns of chroma samples to the left of the current coding block 406C. A column number of the first portion is determined by a column number of the current coding block 406C, and a row number of the second portion is determined by a row number of the current coding block 406C. In some embodiments, the reference area 412 extends one coding block width to the right of a right boundary of the current coding block 406, and one coding block height below a bottom boundary of the current coding block 406. In some embodiments, the reference area 412 is adjusted to include only available samples. Extensions 412E to the reference area 412 are padded in unavailable areas to provide side samples of a filter.

In some embodiments, the reconstructed luma samples 404R and chroma samples 402R of the reference area 412 are used to generate the model parameters in the CCP mode. The reference area 412 may be L-shaped, including bottom left, left, top left, above and above right reference regions. For example, the reference area 412 has a first integer number K (e.g., 6) of reference lines above the current coding block 406C and a second integer number L (e.g., 8) columns to the left of the current coding block 406C. Extensions 412E to the reference area 412 include padded pixels for the reference samples.

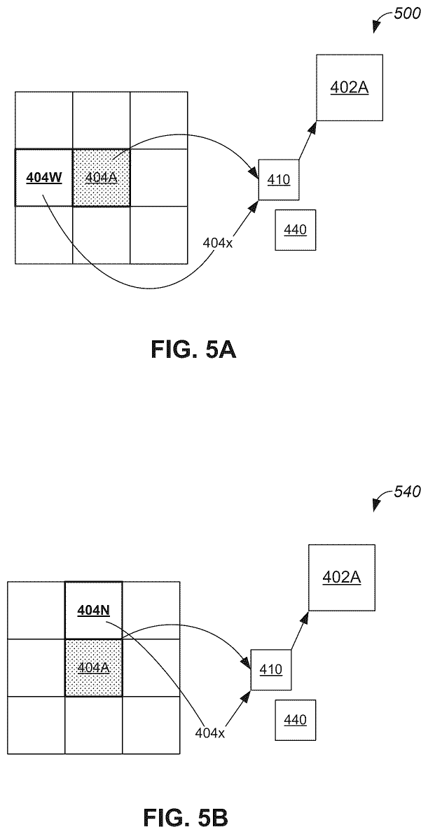

FIG. 5A is a diagram of an example MHCCP mode having a horizontal filter shape 500, in accordance with some embodiments, and FIG. 5B is a diagram of an example MHCCP mode having a vertical filter shape 540, in accordance with some embodiments. Referring to FIG. 5A, in some embodiments, linear terms of luma samples 404L (L) and 404C (C), a non-linear term E, and an offset term F are combined according to the horizontal filter shape 500 of the MHCCP mode. The first chroma sample 402A is predicted as follows:

$$predChromaVal = {c}_{0} C + {c}_{1} L + {c}_{2} E + {c}_{3} F \qquad ( 2 )$$

where predChromaVal is a predicted chroma value of the first chroma sample 402A, C is a value of a first luma sample 404C, L is a value of a left luma sample 404L, and c₀, c₁, c₂, and c₃ are model parameters 410 applied in the MHCCP mode. Referring to FIG. 5B, in some embodiments, linear terms of luma samples 404T (T) and 404C (C), a non-linear term E, and an offset term F are combined according to the vertical filter shape 540. The first chroma sample 402A is predicted as follows:

$$predChromaVal = {c}_{0} C + {c}_{1} T + {c}_{2} E + {c}_{3} F \qquad ( 3 )$$

where T is a value of a top luma sample 404T.

In some embodiments, three model parameters 410 are applied to determine the first chroma samples 402A, thereby reducing a number of model parameters used in the MHCCP mode. One mode parameter 410 can be directly removed (e.g. equal to 0). In some embodiments, the first luma sample 404A collocated with the first chroma sample 402A can be dropped off. In some embodiments, the neighboring luma sample 404X (e.g., left luma sample 404W in equation (2), top luma sample 404N in equation (3)) can be dropped off. A flag is applied to enable or disable the MHCCP mode. In some embodiments, the offset term F can be dropped off, when the model parameter c3 in equations (2) and (3) are set to 0. In an example, the offset term F may be dropped for chroma subsampling formats 4:4:4 or 4:2:2. In some embodiments, the non-linear term E can be dropped off. For example, the non-linear term E may be dropped for chroma subsampling formats 4:4:4 or 4:2:2.

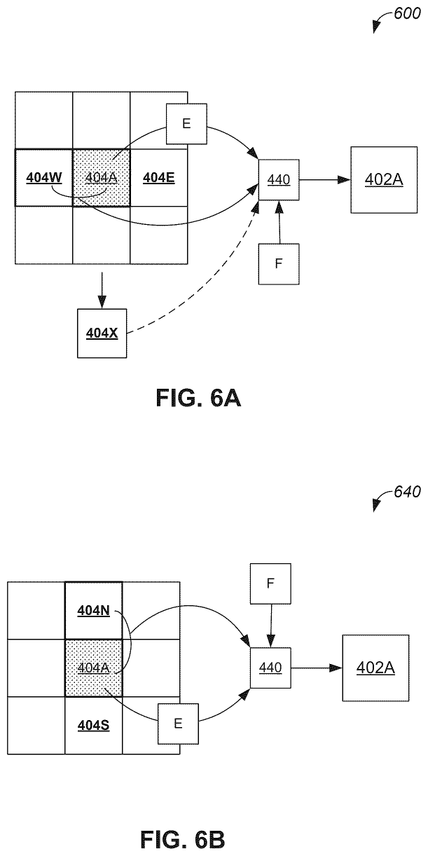

FIG. 6A is a diagram of an example MHCCP mode having a horizontal filter shape 600, in accordance with some embodiments, and FIG. 6B is a diagram of an example MHCCP mode having a vertical filter shape 640, in accordance with some embodiments. A decoder 122 (FIG. 2B) receives a video bitstream 116 including a current coding block 406C of a current image frame 408, wherein the video bitstream includes a first syntax element 420 for a multi-hypothesis cross-component prediction (MHCCP) mode. Based on the first syntax element 420, the decoder 122 determines that the MHCCP mode is enabled to reconstruct a first chroma sample 402A of the current coding block 406C based on a set of one or more luma samples 404 (e.g., luma samples 404A, 404N). The decoder 122 determines that three model parameters 440 (e.g., c₀, c₁, c₂) are used in the MHCCP mode. The three model parameters 440 correspond to a linear term, a non-linear term, and an offset term. The set of one or more luma samples 404 are combined using the three model parameters 440 to generate the first chroma sample 402A of the current coding block 406C, and the decoder 122 reconstructs the current image frame 408 including the first chroma sample 402A of the current coding block 406C.

In some embodiments, the set of one or more luma samples includes a first luma sample 404A that is collocated with the first chroma sample, a second luma sample 404T that is immediately above the first luma sample 404A, and a third luma sample 404L that is immediately to the left of, the first luma sample 404A. The linear term E is one of the first, second, and third luma samples 404A, 404T, and 404L and is combined with a first model parameter c₀. The non-linear term F is a square of the one of the first, second, and third luma samples 404A, 404T, and 404L, and is combined with a second model parameter c₁. In some embodiments, the set of one or more luma samples includes a first luma sample 404A that is collocated with the first chroma sample 402A. The linear term E is the first luma sample 404A, which is further combined with the first model parameter c₀. The non-linear term E is a square of the first luma sample 404A and further combined with the second model parameter c₁. The first chroma sample 402A is determined as follows:

$$predChromaVal = {c}_{0} C + {c}_{1} E + {c}_{2} F . \qquad ( 4 )$$

wherein E is a nonlinear term equal to a square of the first luma sample 404A.

In some embodiments, a first luma sample 404A is collocated with the first chroma sample 402A, and the set of one or more luma samples includes a second luma sample 404X that is immediately adjacent to the first luma sample 404A. The linear term is the second luma sample 404X, which is further combined with the first model parameter c₀. The non-linear term E is a square of the first luma sample 404A and further combined with the second model parameter c₁. The first chroma sample 402A is determined as follows:

$$predChromaVal = {c}_{0} D + {C}_{1} E + {c}_{2} F . \qquad ( 5 )$$

where D is a value of the second luma sample 404X (e.g., a top luma sample 404N (T) in FIG. 5B, a left luma sample 404W (L) in FIG. 5A), and E is a nonlinear term equal to a square of the second luma sample 404X.

Referring to FIGS. 6A and 6B, in some embodiments, the set of one or more luma samples 404 includes a first luma sample 404A that is collocated with the first chroma sample 402A and a second luma sample 404X that is immediately above, or to the left of, the first luma sample 404A. Examples of the second luma sample 404X are a top luma sample 404N in FIG. 6B and a left luma sample 404W in FIG. 6A. The first chroma sample 402A is determined as follows:

$${PredVal}_{hort} = {c}_{0} ( {w}_{0} C + {w}_{1} L ) + {c}_{1} E + {c}_{2} F , or \qquad ( 6 )$$

$${PredVal}_{vert} = {c}_{0} ( {w}_{0} C + {w}_{1} T ) + {c}_{1} E + {c}_{2} F .$$

where PreValₕₒᵣₜ and PreValᵥₑᵣₜ are values of the first chroma sample 402A determined based on a horizontal filter shape 500 and a vertical filter shape 540, respectively; C is a value of the first luma sample 404A; L is a value of the left luma sample 404W; T is a value of the left luma sample 404W; E is a non-linear term; F is an offset term; and c₀, c₁, and c₂ are three model parameters 440 applied in the MHCCP mode.

In some embodiments, the linear term E is a combination of the first luma sample 404A (C) and a second luma sample 404X (e.g., a top luma sample 404N (T) in FIG. 5B, a left luma sample 404W (L) in FIG. 5A), and is further combined with a first model parameter c₀. The non-linear term E is a square of the first luma sample 404A (C) and further combined with a second model parameter c₁. Further, in some embodiments, the linear term is an average of the first luma sample 404A (C) and the second luma sample (e.g., a top luma sample 404N (T) in FIG. 5B, a left luma sample 404W (L) in FIG. 5A). The weights w₀ and w₁ are equal to ½. Alternatively, in some embodiments, the weights w₀ and w₁ are determined based on a prediction block size. Alternatively, in some embodiments, the weights w₀ and w₁ are determined based on a prediction mode used for the first chroma sample 402A. Alternatively, in some embodiments, the weights w₀ and w₁ are determined based on a chroma subsampling format (e.g., 4:4:4, 4:2, :2, or 4:2:0). Alternatively, in some embodiments, the weights w₀ and w₁ are two predetermined values.

In some embodiments, the first chroma sample 402A is generated as follows:

$${PredVal}_{hort} = {c}_{0} ( {w}_{0} C + {w}_{1} F ) + {c}_{1} L + {c}_{2} E , or \qquad ( 7 )$$

$${PredVal}_{vert} = {c}_{0} ( {w}_{0} C + {w}_{1} F ) + {c}_{1} T + {c}_{2} E .$$

A decoder 122 generates a product of a first model parameter c₀ and a weighted combination of a first luma sample 404A that is collocated with the first chroma sample 402A and the offset term F. Further, in some embodiments, the decoder 122 generates a product of a second model parameter c₁ and a second luma sample 404X that is immediately above, or to the left of, the first luma sample 404A. Examples of the second luma sample 404X are a top luma sample 404N in FIG. 6B and a left luma sample 404W in FIG. 6A.

Alternatively, in some embodiments, a second luma sample 404X is immediately above, or to the left of, the first luma sample 404A, which is co-located with the first chroma sample 402A. The first chroma sample 402A is generated as follows:

$${PredVal}_{hort} = {c}_{0} C + {c}_{1} ( {w}_{0} L + {w}_{1} F ) + {c}_{2} E , or \qquad ( 8 )$$

$${PredVal}_{vert} = {c}_{0} C + {c}_{1} ( {w}_{0} T + {w}_{1} F ) + {c}_{2} E .$$

The decoder 122 (FIG. 2B) generates a product of one of the three model parameters 440 (e.g. c₁) and a weighted combination of the second luma sample 404X and the offset term F.

Alternatively, in some embodiments, the first chroma sample 402A is generated as follows:

$${PredVal}_{hort} = {c}_{0} ( {w}_{0} C + {w}_{1} F ) + {c}_{1} ( {w}_{2} L + {w}_{3} F ) + {c}_{2} E , and \qquad ( 9 )$$

$${PredVal}_{vert} = {c}_{0} ( {w}_{0} C + {w}_{1} F ) + {c}_{1} ( {w}_{2} T + {w}_{3} F ) + {c}_{2} E .$$

The decoder 122 (FIG. 2B) generates a product of a first model parameter c₀ and a weighted combination of the first luma sample 404A (C) and/or the offset term F, and a product of a second model parameter c₁ and a weighted combination of the second luma sample 404X and the offset term F. In an example, the second luma sample 404X is one of a top luma sample 404N in FIG. 6B and a left luma sample 404W in FIG. 6A.

Alternatively, in some embodiments, the first chroma sample 402A is generated as follows:

$${PredVal}_{hort} = {c}_{0} ( {w}_{0} C + {w}_{1} E ) + {c}_{1} ( {w}_{2} L + {w}_{3} E ) + {c}_{2} F , and \qquad ( 10 )$$

$${PredVal}_{vert} = {c}_{0} ( {w}_{0} C + {w}_{1} E ) + {c}_{1} ( {w}_{2} T + {w}_{3} E ) + {c}_{2} F .$$

The decoder 122 (FIG. 2B) generates a product of a first model parameter c₀ and a weighted combination of the first luma sample 404A and the non-linear component E, and a product of a second model parameter c₁ and a weighted combination of the second luma sample 404X and the non-linear component E. In an example, the second luma sample 404X is one of a top luma sample 404N in FIG. 6B and a left luma sample 404W in FIG. 6A.

Alternatively, in some embodiments, the first chroma sample 402A is generated as follows:

$${PredVal}_{hort} = {c}_{0} ( {w}_{0} C + {w}_{1} L + {w}_{2} R ) + {c}_{1} E + {c}_{2} F \qquad ( 11 )$$

$${PredVal}_{vert} = {c}_{0} ( {w}_{0} C + {w}_{1} T + {w}_{2} B ) + {c}_{1} E + {c}_{2} F$$

where R is a value of a right luma sample 404E, and B is a value of a bottom luma sample 404S. The decoder 122 (FIG. 2B) determines the linear term based on a weighted combination of a first luma sample 404A (C) that is collocated with the first chroma sample 402A and two or more neighboring luma samples 404X. For example, for a horizontal filter shape 600, the first chroma sample 402A is determined based on a first model parameter c₀ and the linear term including a weighted combination of the luma samples 404A, 404W, and 404E. In another example, for a vertical filter shape 640, the first chroma sample 402A is determined based on a first model parameter c₀ and the linear term including a weighted combination of the luma samples 404A, 404N, and 404S. In some embodiments, the weights w₀, w₁, and w₂ have predefined values, e.g., ½, ¼, and ¼, respectively.

In some embodiments, the non-linear term F in any of equations (1)-(9) is equal to a square of the value of the first luma sample 404A. Alternatively, in some embodiments, the non-linear term F in any of equations (1)-(9) is equal to a square of the value of any luma sample 404X immediately adjacent to the first luma sample 404A. Alternative, in some embodiments, the non-linear term F in any of equations (1)-(9) is determined based on a non-linear combination of a subset of the set of one or more luma samples. For example, the non-linear term F is equal to a product of the values of the first luma sample 404A and one or more luma samples 404X or a linear combination of two or more products of the values of the first luma sample 404A and one or more luma samples 404X. Alternative, in some embodiments, the non-linear term F in any of equations (1)-(9) is determined based on an N-th order of one or more luma samples 404, where N is greater than 2.

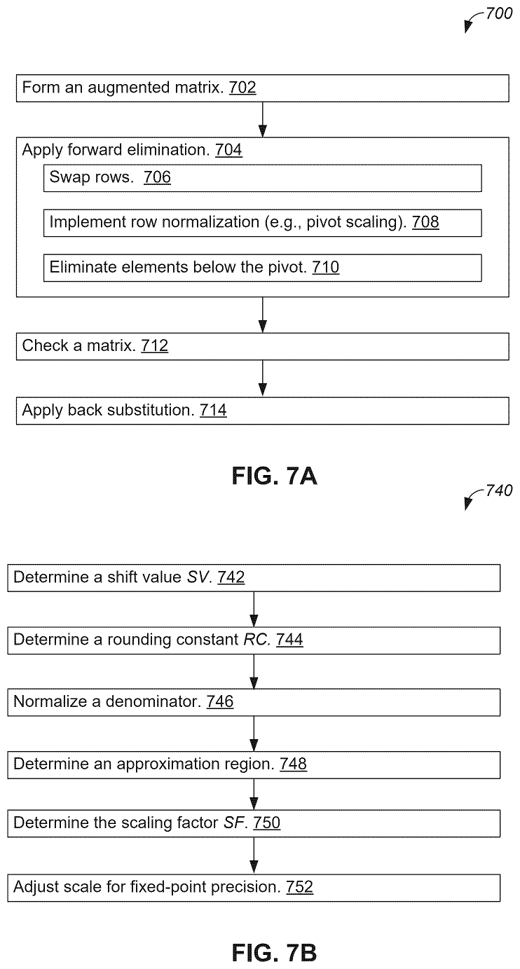

FIG. 7A is a flow diagram of an example least mean square method 700 applied using Gaussian elimination to determine model parameters (e.g., parameters 410 in FIGS. 4 and 5A-5B, parameters 440 in FIGS. 6A and 6B), in accordance with some embodiments. The method 700 include forming (operation 702) an augmented matrix. Linear equations are represented as an augmented matrix, and combine a coefficient matrix A and a vector of constant terms B as follows:

$$A X = B , \qquad ( 4 )$$

where A is an m×4 coefficient matrix, X is a 4×1 vector of unknowns (e.g., [x₁, x₂, x₃, x₄]^{T}), and B is an m×1 column vector of constant terms. In an example, if m>4, a number of equations is greater than a number of unknowns. A least squares solution is obtained by minimizing:

$${min}_{X} {‖ AX - B ‖}^{2} ,$$

which leads to a normal equations: A^{T}AX=A^{T}B. A^{T}A is a 4×4 square matrix to be solved, and A^{T}B is a 4×1 column vector.

In some embodiments, the method 700 further includes forward elimination (operation 704), which further includes row swapping 706, row normalization 708 (e.g., pivot scaling), and element elimination 710 below a pivot. For example, if a matrix element aₖₖ is equal to 0, row k is swapped with row j, which has a higher row index j (e.g., j>k), where aⱼₖ≠0. For row normalization 708, a pivot row k is normalized (e.g., divided by a leading coefficient

$${R}_{k} ← \frac{{R}_{k}}{{a}_{k k}} ) .$$

For each row i>k, one or more elements aᵢₖ are eliminated based on a row operation:

$${R}_{i} ← {R}_{i} - \frac{{a}_{i k}}{{a}_{k k}} {R}_{k} ) ,$$

which ensures that aᵢₖ=0 when i is greater than k. For rows having i>k and columns having j≥k, the following equations are established:

$${A}_{i , j} = {A}_{i , j} - \frac{{A}_{i , k}}{{A}_{k , k}} \cdot {A}_{k , j} , {B}_{i} = {B}_{i} - \frac{{A}_{i , k}}{{A}_{k , k}} \cdot {B}_{k} , \qquad ( 5 )$$

where: A[i, j] are the elements of the coefficient matrix. B[i] are the elements of the right-hand side vector. k represents the current pivot row. i>k represents the rows below the pivot. j>k ensures all elements in the row are updated accordingly. This process is repeated for pivot columns having k equal to 1, 2, . . . , and n−1, until the matrix is reduced to an upper triangular form.

In some embodiments, the method 700 further includes matrix checking 712. The matrix is inspected for inconsistencies. If a row has all zero coefficients but a non-zero constant term, there is no solution. If all coefficients and the constant term in a row are zero, there are an infinite number of solutions.

In some embodiments, the method 700 further includes back substitution 714. The unknowns in X are solved starting from a last row and moving upwards. Stated another way, a last variable in X is solved using the last row. The solved variable values are used to replace the corresponding unknowns in the previous rows and determine remaining unsolved unknowns. This process continues until all unknowns in X are determined.

FIG. 7B is a flow diagram of an example method 740 of approximating a division operation, in accordance with some embodiments. When three model parameters 440 are used in an MHCCP mode to determine a first chroma sample 402A, a decoder 122 (FIG. 2) determines the three model parameters 440 based on reference samples 402R and 404R of a reference area 412 of the current coding block 406C using at least one division operation. In some embodiments, the at least one division operation is implemented based on a shift value SV, a scaling factor SF, and a rounding constant RC. A decoder 122 (FIG. 2B) determines (operation 742) the shift value SV and finds a base-2 logarithm of an absolute value of a denominator to determine how much to normalize the denominator. The decoder 122 further determines (operation 744) the rounding constant RC, e.g., setting the round constant RC to 2^{SV}−1 to improve a precision level in subsequent calculations. The denominator is normalized (operation 746) to a fixed range normDiff and shifted based on shift to fit within a predefined bit range. The decoder 122 may further determine (operation 748) an approximation region (index). The denominator may be partitioned into one of 8 approximation regions based on the fixed range normDiff, which is adjusted using offset values pow2O. The decoder 122 further determines (operation 750) the scaling factor SF. In some embodiments, the scaling factor SF is applied using a quadratic approximation formula, e.g.,

$$S F = W \cdot {x}^{2} - \frac{x}{2} + B ,$$

where coefficients are extracted from precomputed tables (pow2W, pow2B). The decoder 122 adjust (operation 752) scale for a fixed-point precision, and applies bit-shifting to match a system precision. Additionally, in some embodiments, the precomputed tables (pow2W, pow2B) are defined as follows:

$$pow 2 W [ 8 ] = \{ 214 , 153 , 113 , 86 , 67 , 53 , 43 , 35 \} ;$$

$$pow 2 O [ 8 ] = \{ 4822 , 5952 , 6624 , 6792 , 6408 , 5424 , 3792 , 1466 \} ; and$$

$$pow 2 B [ 8 ] = \{ 12784 , 12054 , 11670 , 11583 , 11764 , 12195 , 12870 , 13782 \} .$$

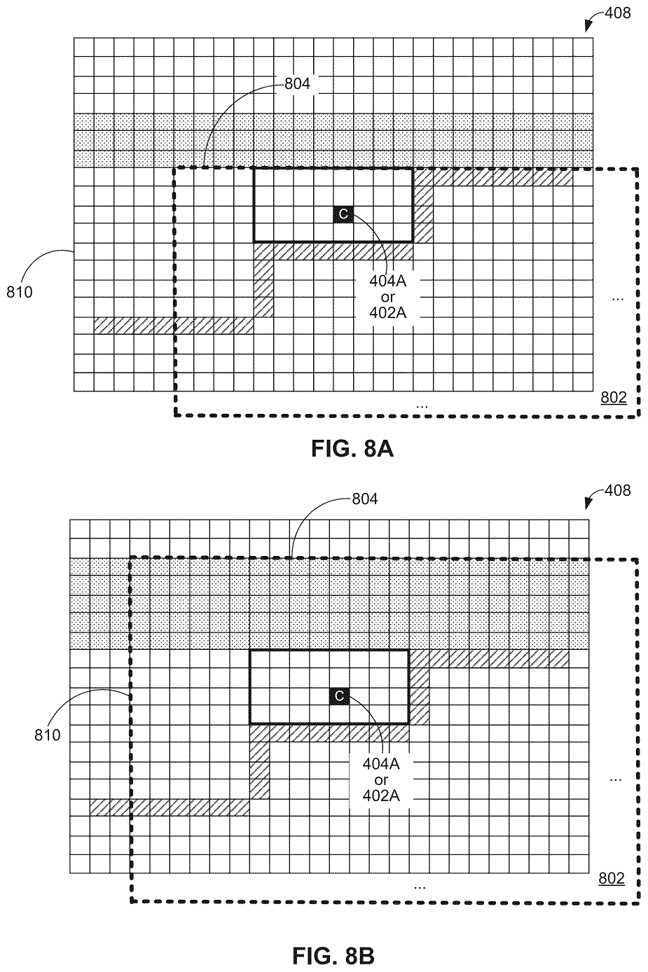

FIG. 8A is an example current image frame 408 in which a current coding block 406C is located at a top boundary 804 of a superblock 802, in accordance with some embodiments, and FIG. 8B is another example current image frame 408 in which a current coding block 406C is located within a superblock 802, in accordance with some embodiments. When three model parameters 440 are used in an MHCCP mode to determine a first chroma sample 402A, a decoder 122 (FIG. 2) determines the three model parameters 440 based on reference samples 402R and 404R of a reference area 412 of the current coding block 406C.

Additionally, in some situations (FIG. 8A), when the current coding block 406C is located at the left boundary 810 or the top boundary 804 of a superblock 802, the reference area 412 includes a first number N₁ of lines of reference samples, which may be stored in a line buffer. In some situations (FIG. 8B), when the current coding block 406C is not located at the left boundary 810 or the top boundary 804 of the superblock 802, the reference area 412 includes a second number N₂ of lines of reference samples. The first number N₁ is smaller than the second number N₂. In an example, the first number N₁ is equal to the maximum allowed reference lines for intra prediction at the boundary 804 or 810. In some embodiments, the first number N₁ of lines of reference samples corresponds to a luma line number of lines (e.g., 6) of reference samples and a chroma line number (e.g., 3) of lines of reference samples. For example, the chroma line number of lines is equal to 1.

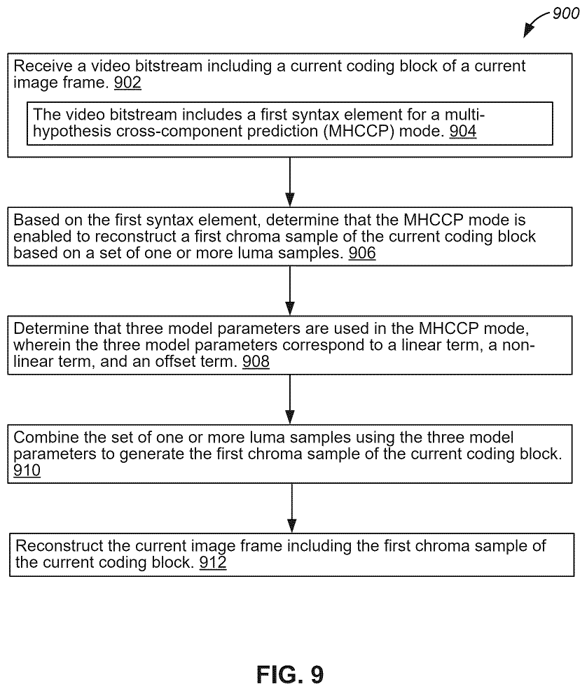

FIG. 9 is a flow diagram illustrating an example method 900 of decoding video, in accordance with some embodiments. The method 900 may be performed at a computing system (e.g., the server system 112, the source device 102, or the electronic device 120) having control circuitry and memory storing instructions for execution by the control circuitry. In some embodiments, the method 900 is performed by executing instructions stored in the memory (e.g., the memory 314) of the computing system. In some embodiments, the method 900 is applied jointly with one or more video codecs, including but not limited to, H.264, H.265/HEVC, H.266/VVC, AV1 and AVS/AVS2/AVS3.

The method 900 is directed to coding a current coding block 406C located at a top boundary 804 of a superblock 802 or a coding tree unit (CTU). Three mode parameters 440 can be utilized for a multi-hypothesis cross-component prediction (MHCCP) mode. A first luma sample 404A is collocated with a first chroma luma sample 402A. In some embodiments, the first luma sample 404A and a neighboring luma sample 404X can be merged by a weighted average and considered as one variable, e.g., in equations (6). In an example, the weights w₀ and w₁ are equal to ½, and used to combine the first luma sample 404A and the neighboring luma sample 404X for the MHCCP model. In another example, the weights w₀ and w₁ depend on a prediction block size. In yet another example, the weights w₀ and w₁ depend on a prediction mode used in first color component. In an example, the weights w₀ and w₁ depend on a chroma subsampling format, e.g., 4:4:4, 4:2:2, or 4:2:0. In an example, the weights w₀ and w₁ have two predefined values.

In some embodiments, the offset term F can be merged with the first luma sample 404A and/or the neighboring luma sample 404X and considered as one variable. In some embodiments, the offset term F is only combined with the first luma sample 404A, e.g., according to equations (7). In some embodiments, the offset term F is only combined with the neighboring luma sample 404X, e.g., according to equations (8). In some embodiments, the offset term F is combined with the first luma sample 404A and/or the neighboring luma sample 404X, e.g. according to equations (9).

In some embodiments, the non-linear term E can be merged with first luma sample 404A and/or the neighboring luma sample 404X, and considered as one variable. In some embodiments, the non-linear term E is only combined with the first luma sample 404A. In some embodiments, the non-linear term E is only combined with the neighboring luma sample 404X. In some embodiments, the non-linear term E is combined with the first luma sample 404A and the neighboring luma sample 404X, e.g., e.g., according to equations (10).

In some embodiments, additional neighboring luma samples 404X (e.g., a right luma sample 404E, a bottom luma sample 404S) can be used, e.g., according to equations (11). The weights w₀, w₁, and w₂ may have predefined values, and are applied to combine three luma samples to form a linear term corresponding to a first model parameter c₀.

In some embodiments, a plurality of MHCCP modes are employed, and three model parameters 440 are used. In some embodiments, only the co-located first luma sample 404A fetched, and its luma value or a square of the luma value may be used. For example, according to equation (4), the first luma sample 404A is applied to generate the first chroma sample 402A. Alternatively, in some embodiments, according to equation (5), the left luma sample 404W that is located immediately to the left of the first luma sample 404A is used, and the non-linear term E includes a squared term of the left luma sample 404W (L). Equation (5) is updated as follows:

$$predChromaVal = {c}_{0} L + {c}_{1} {L}^{2} + {c}_{2} F ,$$

where L is a value of the left luma sample 404W. In another example, the top luma sample 404N that is located immediately on the top of the first luma sample 404A is used, and the non-linear term E includes a squared term of the top luma sample 404N (T). Equation (5) is updated as follows:

$$predChromaVal = {c}_{0} T + {c}_{1} {T}^{2} + {c}_{2} F ,$$

where T is a value of the top luma sample 404N.

In some embodiments, the non-linear term E includes a squared term, which is generated from the first luma sample 404A that is collocated with the first chroma sample 402A, and the linear term E can be generated from either the top luma sample 404N (T), the first luma sample 404A (C), or the left luma sample 404W (L). The first luma sample 404A (C) is used in the non-linear term E. Only one of equations (4) and (5) is applied to a coding block. In an example, the non-linear term E is a squared term in equations (4) and (5), and other parts in these two equations are kept unchanged.

In some embodiments, three model parameters 410 are applied to determine the first chroma samples 402A. One mode parameter 410 can be directly removed (e.g. equal to 0). In some embodiments, the first luma sample 404A collocated with the first chroma sample 402A can be dropped off. In some embodiments, the neighboring luma sample 404X (e.g., left luma sample 404W in equation (2), top luma sample 404N in equation (3)) can be dropped off. A flag is applied to enable or disable the MHCCP mode. In some embodiments, the offset term F can be dropped off, when the model parameter c3 in equations (2) and (3) are set to 0. In an example, the offset term F may be dropped for chroma subsampling formats 4:4:4 or 4:2:2. In some embodiments, the non-linear term E can be dropped off. For example, the non-linear term E may be dropped for chroma subsampling formats 4:4:4 or 4:2:2.

In some embodiments, when a current coding block 406C is located at a left superblock boundary 810 (FIG. 8A), reference samples from up to Nᵢ left columns can be fetched and employed for deriving the model parameters 410 or 440. When the current coding block 406C is not located at the superblock boundary 804 or 810 (FIG. 8B), reference samples from up to N₂ rows and/or columns can be fetched and employed for deriving the model parameters 410 or 440. N₁ is smaller than N₂. In some embodiments, N₁ is the same as the maximum allowed reference lines for intra prediction at the left superblock boundary 810. In some embodiments, the value of N₁ may be different for luma and chroma components for the current coding block 406C located at the left superblock boundary 810. In an example, N₁ is set to 1 for chroma component.

When three model parameters 440 are used in an MHCCP mode to determine a first chroma sample 402A, a decoder 122 (FIG. 2) determines the three model parameters 440 based on reference samples 402R and 404R of a reference area 412 of the current coding block 406C, e.g., using at least one division operation. In some embodiments (FIG. 7B), the at least one division operation is implemented based on a shift value SV, a scaling factor SF, and a rounding constant RC. A decoder 122 (FIG. 2B) determines (operation 742) the shift value SV and finds a base-2 logarithm of an absolute value of a denominator to determine how much to normalize the denominator. The decoder 122 further determines (operation 744) the rounding constant RC, e.g., setting the round constant RC to 2^{SV}−1 to improve a precision level in subsequent calculations. The denominator is normalized (operation 746) to a fixed range normDiff and shifted based on shift to fit within a predefined bit range. The decoder 122 may further determine (operation 748) an approximation region (index). The denominator may be partitioned into one of 8 approximation regions based on the fixed range normDiff, which is adjusted using offset values pow2O. The decoder 122 further determines (operation 750) the scaling factor SF. In some embodiments, the scaling factor SF is applied using a quadratic approximation formula, e.g.,

$$S F = W \cdot {x}^{2} - \frac{x}{2} + B ,$$

where coefficients are extracted from precomputed tables (pow2W, pow2B). The decoder 122 adjust (operation 752) scale for a fixed-point precision, and applies bit-shifting to match a system precision. Additionally, in some embodiments, the precomputed tables (pow2W, pow2B) are defined as follows:

$$pow 2 W [ 8 ] = \{ 214 , 153 , 113 , 86 , 67 , 53 , 43 , 35 \} ;$$

$$pow 2 O [ 8 ] = \{ 4822 , 5952 , 6624 , 6792 , 6408 , 5424 , 3792 , 1466 \} ; and$$

$$pow 2 B [ 8 ] = \{ 12784 , 12054 , 11670 , 11583 , 11764 , 12195 , 12870 , 13782 \} .$$

Although FIG. 9 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In some implementations, a method 900 is implemented for decoding video data. The method 900 includes receiving (operation 902) a video bitstream including a current coding block of a current image frame, wherein the video bitstream includes (operation 904) a first syntax element for a multi-hypothesis cross-component prediction (MHCCP) mode; based on the first syntax element, determining (operation 906) that the MHCCP mode is enabled to reconstruct a first chroma sample of the current coding block based on a set of one or more luma samples; determining (operation 908) that three model parameters are used in the MHCCP mode, wherein the three model parameters correspond to a linear term, a non-linear term, and an offset term; combining (operation 910) the set of one or more luma samples using the three model parameters to generate the first chroma sample of the current coding block; and reconstructing (operation 912) the current image frame including the first chroma sample of the current coding block.
(A2) In some implementations of A1, the set of one or more luma samples includes a first luma sample that is collocated with the first chroma sample and a second luma sample that is immediately above, or to the left of, the first luma sample; the linear term is the second luma sample and further combined with a first model parameter; and the non-linear term is a square of the first luma sample and further combined with a second model parameter.
(A3) In some implementations of A1, the set of one or more luma samples includes a first luma sample that is collocated with the first chroma sample; the linear term is the first luma sample and further combined with a first model parameter; and the non-linear term is a square of the second luma sample and further combined with a second model parameter.
(A4) In some implementations of A1, the set of one or more luma samples includes a first luma sample that is collocated with the first chroma sample, a second luma sample that is immediately above the first luma sample, and a third luma sample that is immediately to the left of, the first luma sample; the linear term is one of the first, second, and third luma samples and is combined with a first model parameter and; and the non-linear term is a square of the one of the first, second, and third luma samples, and is combined with a second model parameter.
(A5) In some implementations of A1, combining the set of one or more luma samples using the three model parameters further comprises: determining the linear term a weighted combination of a first luma sample that is collocated with the first chroma sample and a second luma sample that is immediately above, or to the left of, the first luma sample; and generating a product of a first model parameter and the weighted combination.
(A6) In some implementations of A5, the weighted combination is an average of the first luma sample and the second luma sample.
(A7) In some implementations of A5 or A6, the method 900 includes determining at least one weight based on a prediction block size of a prediction block including the first chroma sample; and determining the weighted combination of the first luma sample and the second luma sample based on the at least one weight.
(A8) In some implementations of any of A5-A7, the method 900 includes identifying a chroma subsampling format of the current coding block; determining at least one weight based on the chroma subsampling format; and determining the weighted combination of the first luma sample and the second luma sample based on the at least one weight.
(A9) In some implementations of A5 or A6, the first luma sample and the second luma sample correspond to two predefined weights, the method further comprising: determining the weighted combination of the first luma sample and the second luma sample based on the two predefined weights.
(A10) In some implementations of A5 or A6, combining the set of one or more luma samples using the three model parameters further comprises: generating a product of a first model parameter and a weighted combination of a first luma sample that is collocated with the first chroma sample and the offset term.
(A11) In some implementations of A9, combining the set of one or more luma samples using the three model parameters further comprises: generating a product of a second model parameter and a second luma sample that is immediately above, or to the left of, the first luma sample.
(A12) In some implementations of A1, the set of one or more luma samples includes a first luma sample that is collocated with the first chroma sample and a second luma sample that is immediately above, or to the left of, the first luma sample, and combining the set of one or more luma samples using the three model parameters further comprises: generating a product of one of the three model parameters and a weighted combination of the second luma sample and the offset term.
(A13) In some implementations of A1, the set of one or more luma samples includes a first luma sample that is collocated with the first chroma sample and a second luma sample that is immediately above, or to the left of, the first luma sample, and combining the set of one or more luma samples using the three model parameters further comprises at least one of: generating a product of a first model parameter and a weighted combination of the first luma sample and the offset term; and generating a product of a second model parameter and a weighted combination of the second luma sample and the offset term.
(A14) In some implementations of any of A1-A13, combining the set of one or more luma samples using the three model parameters further comprises: generating the non-linear term based on a non-linear combination of a subset of the set of one or more luma samples.
(A15) In some implementations of A1, the set of one or more luma samples includes a first luma sample that is collocated with the first chroma sample and a second luma sample that is immediately above, or to the left of, the first luma sample, and combining the set of one or more luma samples using the three model parameters further comprises: generating a non-linear component based on a subset of the set of one or more luma samples.
(A16) In some implementations of A15, combining the set of one or more luma samples using the three model parameters further comprises at least one of: generating a product of a first model parameter and a weighted combination of the first luma sample and the non-linear component; and generating a product of a second model parameter and a weighted combination of the second luma sample and the non-linear component.
(A17) In some implementations of A1, combining the set of one or more luma samples using the three model parameters further comprises: determining the linear term based on a product of a first model parameter and a weighted combination of a first luma sample that is collocated with the first chroma sample and two or more neighboring luma samples.
(A18) In some implementations of A16, the two or more neighboring luma samples include a left luma sample and a right luma sample.
(A19) In some implementations of A16, the two or more neighboring luma samples include a top luma sample and a bottom luma sample.
(A20) In some implementations of any of A1-A18, the method 900 further includes determining the three model parameters based on reference samples of a reference area of the current coding block using at least one division operation.
(A21) In some implementations of A20, the at least one division operation further comprises: determining a shift value, a scaling factor, and a rounding constant.
(A22) In some implementations of any of A1-A21, the method includes determining the three model parameters based on reference samples of a reference area of the current coding block, wherein: when the current coding block is located at a left or top boundary of a superblock, the reference area includes a first number of lines of reference samples; when the current coding block is not located at the left or top boundary of the superblock, the reference area includes a second number of lines of reference samples; and the first number is smaller than the second number.
(A23) In some implementations of A22, the first number is equal to the maximum allowed reference lines for intra prediction at the boundary.
(A24) In some implementations of A22, the first number of lines of reference samples corresponds to a luma line number of lines of reference samples and a chroma line number of lines of reference samples.
(A25) In some implementations of A24, the chroma line number of lines is equal to 1.
(A26) In some implementations, the method includes receiving video data comprising a current coding block of a current image frame; encoding the current image frame; transmitting the encoded current image frame via a video bitstream; and signaling, via the video bitstream, a first syntax element for a multi-hypothesis cross-component prediction (MHCCP) mode indicating whether to reconstruct a first chroma sample of the current coding block based on a set of one or more luma samples; wherein when the MHCCP mode is enabled, the set of one or more luma samples are combined using the model parameters corresponding to a linear term, a non-linear term, and an offset term to generate the first chroma sample of the current coding block.
(A26) In some embodiments of A25, the method is implemented to enable the features of any of A2-A24.
(A27) In some implementations, the method includes obtaining a source video sequence including a current image frame having a current coding block; and performing a conversion between the source video sequence and a video bitstream, wherein the video bitstream comprises: the current image frame having the current coding block; and a first syntax element for a multi-hypothesis cross-component prediction (MHCCP) mode indicating whether to reconstruct a first chroma sample of the current coding block based on a first luma sample and a set of one or more luma samples; wherein when the MHCCP mode is enabled, the set of one or more luma samples are combined using the model parameters corresponding to a linear term, a non-linear term, and an offset term to generate the first chroma sample of the current coding block.
(A28) In some embodiments of A27, the method is implemented to enable the features of any of A2-A24.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A24 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A24 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for decoding video data, comprising:
receiving a video bitstream including a current coding block of a current image frame, wherein the video bitstream includes a first syntax element for a multi-hypothesis cross-component prediction (MHCCP) mode;
based on the first syntax element, determining that the MHCCP mode is enabled to reconstruct a first chroma sample of the current coding block based on a set of one or more luma samples;
determining that three model parameters are used in the MHCCP mode, wherein the three model parameters correspond to a linear term, a non-linear term, and an offset term;
combining the set of one or more luma samples using the three model parameters to generate the first chroma sample of the current coding block; and
reconstructing the current image frame including the first chroma sample of the current coding block.

2. The method of claim 1, wherein:
the set of one or more luma samples includes a first luma sample that is collocated with the first chroma sample and a second luma sample that is immediately above, or to the left of, the first luma sample;
the linear term is the second luma sample and further combined with a first model parameter; and
the non-linear term is a square of the first luma sample and further combined with a second model parameter.

3. The method of claim 1, wherein:
the set of one or more luma samples includes a first luma sample that is collocated with the first chroma sample;
the linear term is the first luma sample and further combined with a first model parameter; and
the non-linear term is a square of the second luma sample and further combined with a second model parameter.

4. The method of claim 1, wherein:
the set of one or more luma samples includes a first luma sample that is collocated with the first chroma sample, a second luma sample that is immediately above the first luma sample, and a third luma sample that is immediately to the left of, the first luma sample;
the linear term is one of the first, second, and third luma samples and is combined with a first model parameter and; and
the non-linear term is a square of the one of the first, second, and third luma samples, and is combined with a second model parameter.

5. The method of claim 1, wherein combining the set of one or more luma samples using the three model parameters further comprises:
determining the linear term a weighted combination of a first luma sample that is collocated with the first chroma sample and a second luma sample that is immediately above, or to the left of, the first luma sample; and
generating a product of a first model parameter and the weighted combination.

6. The method of claim 5, wherein the weighted combination is an average of the first luma sample and the second luma sample.

7. The method of claim 5, further comprising:
determining at least one weight based on a prediction block size of a prediction block including the first chroma sample; and
determining the weighted combination of the first luma sample and the second luma sample based on the at least one weight.

8. The method of claim 5, further comprising:
identifying a chroma subsampling format of the current coding block; and
determining at least one weight based on the chroma subsampling format; and
determining the weighted combination of the first luma sample and the second luma sample based on the at least one weight.

9. The method of claim 5, wherein the first luma sample and the second luma sample correspond to two predefined weights, the method further comprising:
determining the weighted combination of the first luma sample and the second luma sample based on the two predefined weights.

10. The method of claim 1, wherein combining the set of one or more luma samples using the three model parameters further comprises:
generating a product of a first model parameter and a weighted combination of a first luma sample that is collocated with the first chroma sample and the offset term.

11. The method of claim 9, wherein combining the set of one or more luma samples using the three model parameters further comprises:
generating a product of a second model parameter and a second luma sample that is immediately above, or to the left of, the first luma sample.

12. The method of claim 1, wherein the set of one or more luma samples includes a first luma sample that is collocated with the first chroma sample and a second luma sample that is immediately above, or to the left of, the first luma sample, and combining the set of one or more luma samples using the three model parameters further comprises:
generating a product of one of the three model parameters and a weighted combination of the second luma sample and the offset term.

13. The method of claim 1, wherein the set of one or more luma samples includes a first luma sample that is collocated with the first chroma sample and a second luma sample that is immediately above, or to the left of, the first luma sample, and combining the set of one or more luma samples using the three model parameters further comprises at least one of:
generating a product of a first model parameter and a weighted combination of the first luma sample and the offset term; and
generating a product of a second model parameter and a weighted combination of the second luma sample and the offset term.

14. The method of claim 1, wherein combining the set of one or more luma samples using the three model parameters further comprises:
generating the non-linear term based on a non-linear combination of a subset of the set of one or more luma samples.

15. The method of claim 1, wherein the set of one or more luma samples includes a first luma sample that is collocated with the first chroma sample and a second luma sample that is immediately above, or to the left of, the first luma sample, and combining the set of one or more luma samples using the three model parameters further comprises:
generating a non-linear component based on a subset of the set of one or more luma samples.

16. The method of claim 15, wherein combining the set of one or more luma samples using the three model parameters further comprises at least one of:
generating a product of a first model parameter and a weighted combination of the first luma sample and the non-linear component; and
generating a product of a second model parameter and a weighted combination of the second luma sample and the non-linear component.

17. The method of claim 1, wherein combining the set of one or more luma samples using the three model parameters further comprises:
determining the linear term based on a product of a first model parameter and a weighted combination of a first luma sample that is collocated with the first chroma sample and two or more neighboring luma samples.

18. The method of claim 1, further comprising:
determining the three model parameters based on reference samples of a reference area of the current coding block using at least one division operation.

19. A computing system, comprising:
control circuitry; and
memory storing one or more programs configured to be executed by the control circuitry, the one or more programs further comprising instructions for:
receiving video data comprising a current coding block of a current image frame;
encoding the current image frame;
transmitting the encoded current image frame via a video bitstream; and
signaling, via the video bitstream, a first syntax element for a multi-hypothesis cross-component prediction (MHCCP) mode indicating whether to reconstruct a first chroma sample of the current coding block based on a set of one or more luma samples;
wherein when the MHCCP mode is enabled, the set of one or more luma samples are combined using the model parameters corresponding to a linear term, a non-linear term, and an offset term to generate the first chroma sample of the current coding block.

20. A non-transitory computer-readable storage medium storing one or more programs for execution by control circuitry of a computing system, the one or more programs comprising instructions for:
obtaining a source video sequence including a current image frame having a current coding block; and
performing a conversion between the source video sequence and a video bitstream, wherein the video bitstream comprises:
the current image frame having the current coding block; and
a first syntax element for a multi-hypothesis cross-component prediction (MHCCP) mode indicating whether to reconstruct a first chroma sample of the current coding block based on a first luma sample and a set of one or more luma samples;
wherein when the MHCCP mode is enabled, the set of one or more luma samples are combined using the model parameters corresponding to a linear term, a non-linear term, and an offset term to generate the first chroma sample of the current coding block.
